(19) United States
(12) Patent Application Publication
(10) Pub. No.: US 2008/0269925 A1
(43) Pub. Date: Oct. 30, 2008

(54) Method and apparatus for managing billiard tournaments

(76) Inventor: Daniel S. Lita, Gresham, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/789,667

(22) Filed: Apr. 24, 2007

(51) Int. Cl. G06F 19/00

(52) U.S. Cl. 700/92; 463/3; 473/1

(57) ABSTRACT

A billiard tournament management system utilizes a base computer which is in communication with individual microprocessor touch screen display units which are associated with specific billiard tables. The base computer and microprocessor/display units together are programmed to receive, store and display identifying indicia for each tournament participant, build and maintain a tournament bracket, receive, store and display results of games being played in the tournament, and assign tables to ensuing games. Data can be inputted into the system through both the base computer and the individual microprocessor/display units.

### BACKGROUND OF THE INVENTION

Billiard tournaments can range from a few tables in a bar or pool hall to large regional or national tournaments which take place in large casinos or convention facilities. Winners can be determined by head to head individual or team, single or double elimination match play, or by complex scoring systems. In either event, it is necessary to build and maintain a tournament bracket, keep track of who wins and loses individual matches, and the score of these matches, and assign tables for playing the next round of the tournament. Typically, this is done manually or on a spreadsheet program on a single digital computer. This process is time consuming and makes it difficult to communicate the information to all of the participants of the tournament in a timely fashion.

### BRIEF SUMMARY OF THE INVENTION

The subject invention overcomes the problem of managing a billiard tournament by providing an automated tournament management system. The system includes a base computer which is in communication with a plurality of individual microprocessor/touch screen displays. Together they are programmed to receive, store and display individual player indicia, build and maintain a tournament bracket, receive and store progress of individual matches being played in the tournament, and assigning tables for ensuing matches.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a schematic view showing a billiard tournament management system embodying the subject invention.

FIG. 2 is a billiard table lamp containing a display screen which is part of the invention.

FIG. 3 is a portion of a billiard table containing the display screen.

FIGS. 4-6 are display screens which are used for entering participant information into the system.

FIG. 7 is a screen identifying the participant before the start of a match.

FIG. 8 is a screen showing information displayed during the playing of the match.

FIG. 9 is a schematic view of an electronic ball reading system.

### DETAILED DESCRIPTION OF PREFERRED EMBODIMENT

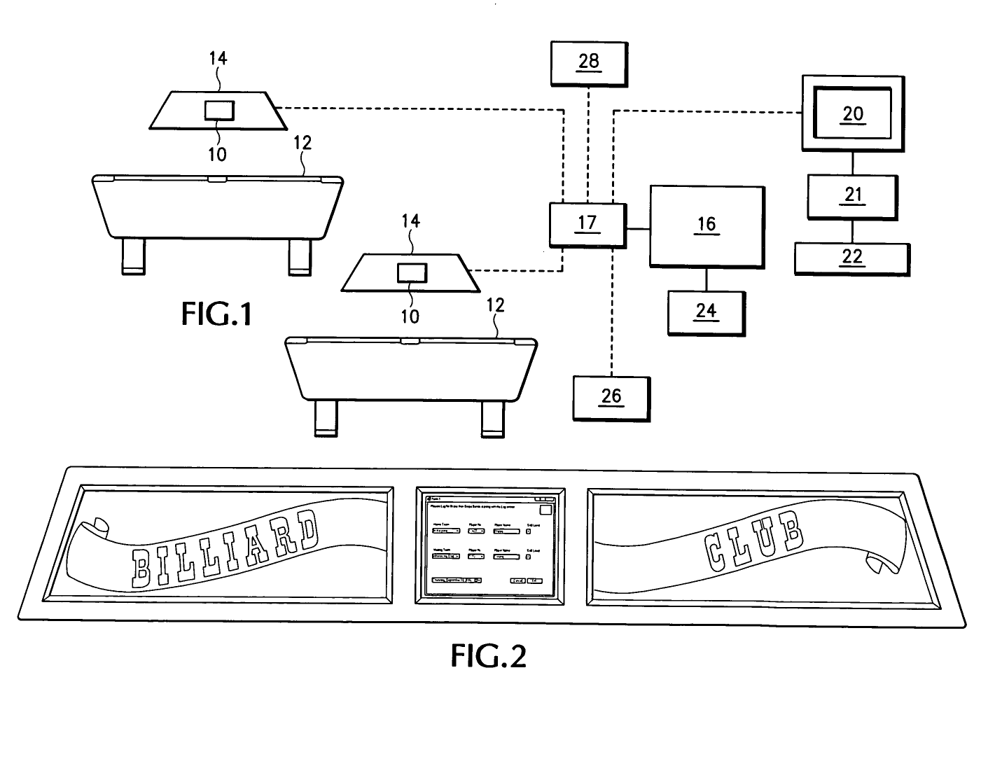

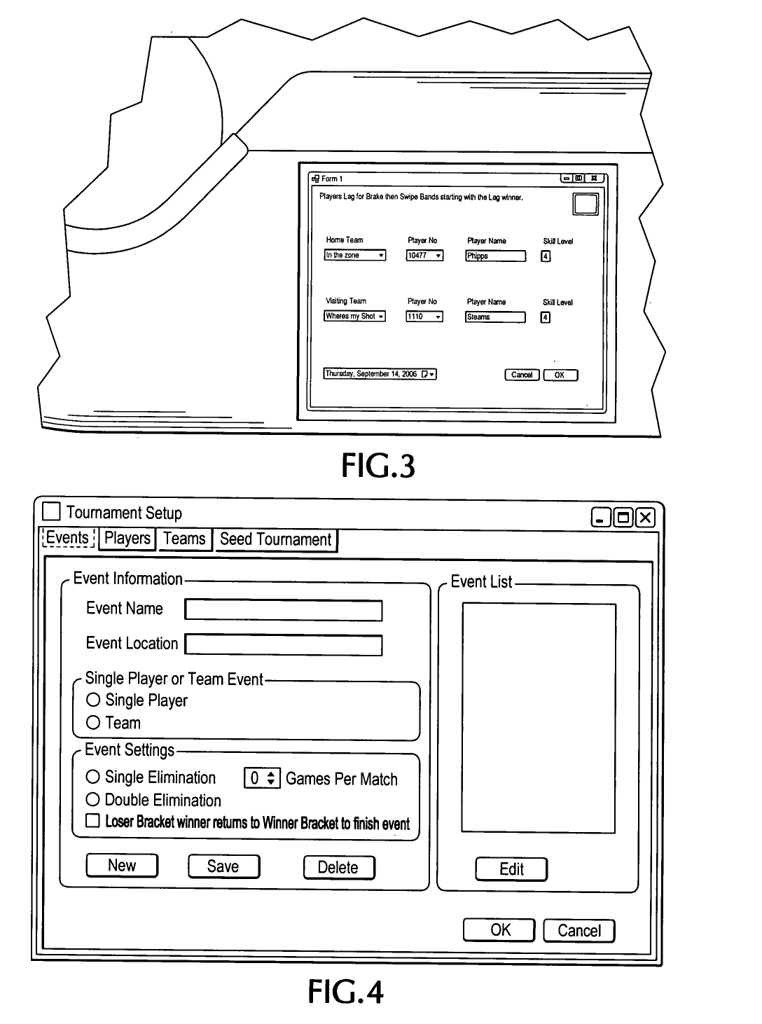

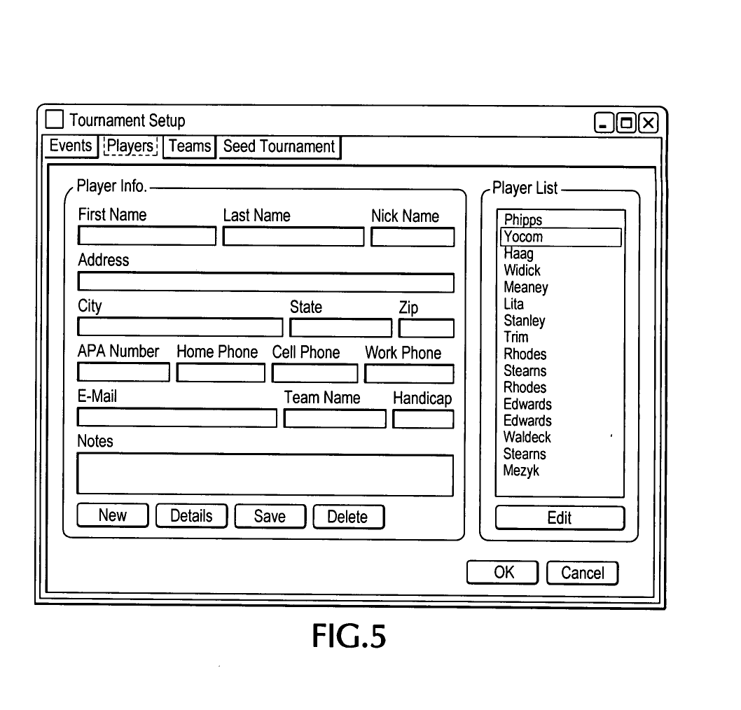

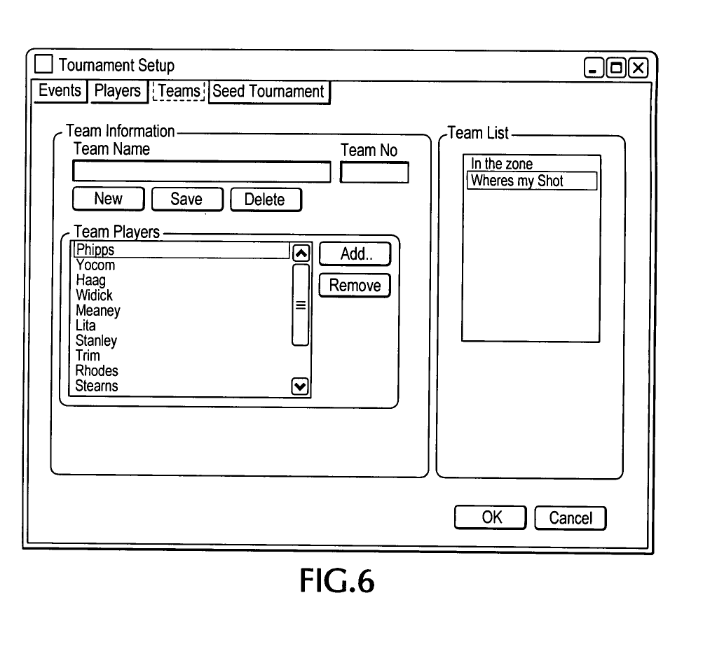

Referring now to FIG. 1 of the drawings, a billiard tournament management system includes a plurality of individual microprocessor/touch screen display units 10. In the embodiments illustrated, there is an individual microprocessor/display unit for each billiard table 12. In one embodiment it is embedded into the lamp 14 which is located over the table, FIG. 2. In another embodiment it is embedded in the table 12 itself, FIG. 3. However, one microprocessor/display unit could be utilized for several tables and it could be a freestanding unit or be embedded in another piece of billiard equipment. A microprocessor that works for this application is the core-PXA 270 single board microprocessor manufactured by Phytech Technology with the MS Windows CEv 5.00 operating system installed on it. Programming of the microprocessor will be explained later. The individual microprocessor/display units communication with a base digital computer 16. Preferably this is accomplished through a wireless network 17, but it could be through hard wiring. The base computer could be custom designed for this application or a commercially available PC or Mac desktop or laptop. The base computer is programmed to receive, store and display personal identifying indicia for each team or player, build and maintain a tournament bracket, receive, store and display the progress and results of individual matches and assign tables for ensuing matches. Personal identifying indicia can include such things as name, address, phone number, handicap or skill level and prior tournament history. In the event of team play, it also can include the team members and captain. Representative screens showing how information is entered relating to a particular event, player data and team information are shown in FIGS. 3-5 respectively. The bracket can be either single or double elimination and can include statistics for previously played matches in the tournament. Scoring can be based on individual or team play with or without handicaps.

If desired, players can be provided with individual readable media, such as a card or bracelet, which contains personal and team information. Players can then sign in at a tournament simply by having their media read by a suitable media reader. This makes checking in at the tournament quicker and eliminates mistakes.

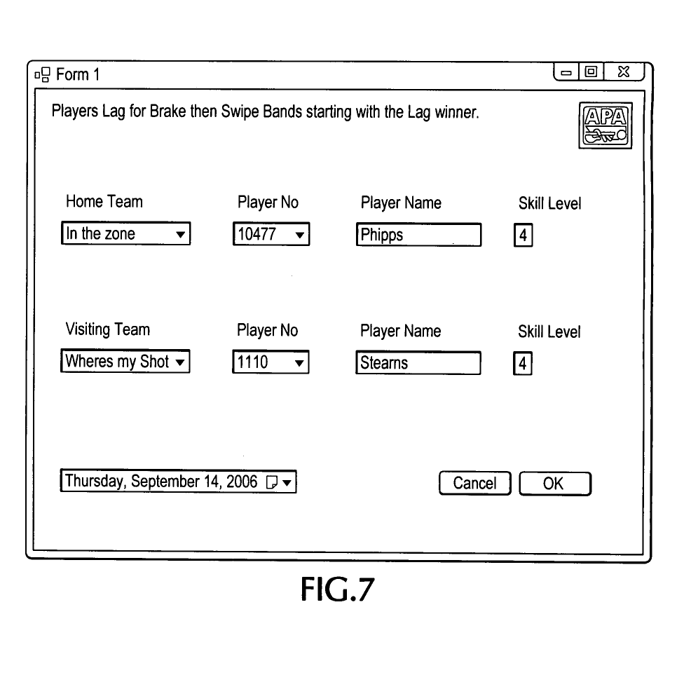

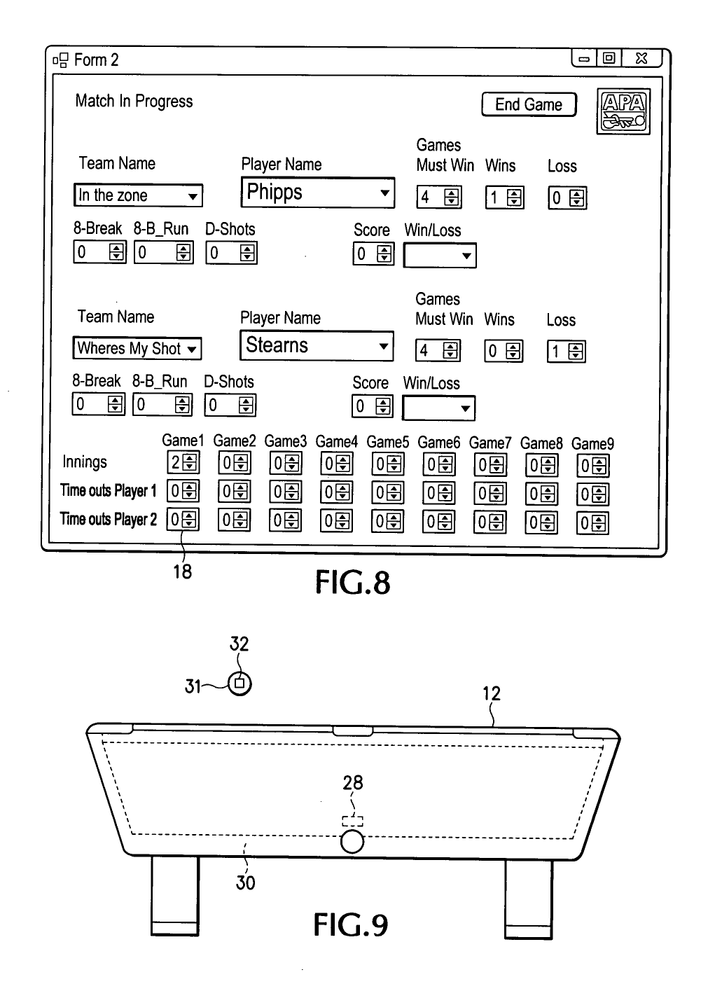

The individual microprocessor/display units are programmed to receive data from the base computer 16 relating to a game that is to be played on the table associated with that microprocessor/display unit. A representative screen showing information about a match that is about to start is shown in FIG. 7. The individual microprocessor/display units are also programmed to allow the players to input information regarding the score as the game progresses and to transmit this information to the base computer. The data is entered by the player by touching appropriate scrolling indicia on the display screen. A representative screen showing information about a match being played is shown in FIG. 8. In the screen illustrated, scrolling is accomplished by touching up and down arrows 18. Information entered on the individual microprocessor/display unit is sent to the base computer where it is stored. Real time scoring of the matches being played is provided by the base computer and sent to the individual display units. As individual matches are completed the base computer updates the bracket. The base computer also will assign pairings and table assignments for the next round of matches and place the information relating to each match on the appropriate individual microprocessor/display units.

The base computer can also receive other material of interest to players and place it on the individual microprocessor/display units. Such material can include information regarding scheduling for that tournament, information about tournament-related events, information regarding future tournaments, specials available to tournament participants and general advertising.

The system also may include a central display 20 which communicates with the base computer through the wireless network 17. Information that is of interest to tournament participants and spectators can be displayed on the central display. The central display could simply show the bracket all the time but also could have a microprocessor 21 and keyboard 22 associated with it which would allow it to be used for viewing scoring information relating to matches in progress or that have been completed. If desired, the microprocessor 21 could even be programmed to permit players to input personal data and send it to the base computer at the start of the tournament.

The system also could include a database 24 associated with the base computer 16 which allows relevant information regarding a tournament in progress and future tournaments to be accessed from a Web site. The Web site could have sections, in which access is limited, where information, such as entry forms, could be sent to the base computer. Through the Web site people not at the tournament could follow its progress and participants could obtain scheduling information when offsite.

The system also could include a hand-held PC 26 having a touch screen which would allow accessing the wireless network 17. The handheld could be programmed to have the same capabilities as the individual microprocessor/display units or only a portion of these capabilities. It could be used as a substitute for the individual microprocessor/display units or as a supplement to them. It could be programmed to only view data or to view and input data.

In order to be more fully automatic, a radio frequency identification tag reader 28 (RFID reader) can be placed in the return passageway 30 of a pool table 12, shown schematically in FIG. 4. Each ball 31 being used on that table has an RFID tag 32 embedded in it which identifies that particular ball and is readable by the RFID reader. The RFID reader communicates with the base computer 16 through the wireless network 17. Thus, the score of games being played can automatically be computed by the base computer and transmitted to the individual microprocessor/display units.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I claim:

1. A billiard tournament management system comprising:
(a) a plurality of individual microprocessor/touch screen display units;
(b) each said individual microprocessor/display units being associated with at least one specific billiard table being used in a tournament;
(c) a base digital computer which communicates with said individual microprocessor/display units;
(d) said base computer being programmed to receive, store and display identifying indicia for each tournament participant, build and maintain a tournament bracket, receive, store and display progress and results of individual games being played in said tournament, and send selective portions of such information to said individual microprocessor/display units; and
(e) said individual microprocessor/display units being programmed to receive data relevant to games being played in said tournament and send data from games being played to said base computer.

2. The system of claim 1 wherein said individual microprocessor/display units are embedded in light fixtures which are suspended above billiard tables.

3. The system of claim 1 including at least one hand-held touch screen PC which communications with said base computer and is programmed to receive data relevant to games being played in said tournament and sending data about games being played to said base computer.

4. The system of claim 1 including a central display which displays the current status of the tournament bracket.

5. The system of claim 1 including means for accessing and viewing selected information in said base computer and inputting data to said base computer on an Internet Web page.

6. The system of claim 1 including:
(a) a radio frequency identification reader associated with a ball return passageway in a billiard table being used in a billiard tournament;
(b) radio frequency identification tags which are embedded in and associated with specific billiard balls used on said table, said tags being readable by said reader when said balls pass through said ball return passageway; and
(c) said reader being in communication with said base computer and said base computer being programmed to keep the score of a game being played based on input from said reader.

7. A system for tracking the score of a billiards game comprising:
(a) a radio frequency identification reader associated with a ball return passageway in a billiard table;
(b) radio frequency identification tags which are embedded in and associated with specific billiard balls being used on said table, said tags being readable by said reader when the balls pass through said return ball passageway; and
(c) said reader being in communication with a digital computer which is programmed to keep the score of a game being played on said table based on input from said reader.

8. A method of managing a billiard tournament, comprising:
(a) entering player data relating to individual players in the tournament into a base digital computer that is programmed to receive, store and display such data and build and maintain a tournament bracket therefrom;
(b) entering game statistics into individual microprocessor/touch screen display units, each of which is associated with at least one billiard table being used in a tournament;
(c) transmitting game statistics from said individual microprocessor/display units to said base computer;
(d) using said game statistics from said base computer to compute scores of individual games and to build a tournament bracket; and
(e) displaying said tournament bracket.

9. The method of claim 8 wherein said tournament bracket is displayed on said individual microprocessor/display units.

10. The method of claim 8 wherein said tournament bracket is displayed on a central display.

11. The method of claim 8 including the step of displaying said player data.

12. The method of claim 11 wherein said player data is displayed on said individual microprocessor/display units.

13. The method of claim 11 wherein said player data is displayed on a central display.

14. The method of claim 8 including the step of displaying said game statistics.

15. The method of claim 14 wherein said game statistics are displayed on said individual microprocessor/display units.

16. The method of claim 14 wherein said game statistics are displayed on a central display.

17. The method of claim 8 including the step of accessing and viewing selected information in said base computer and of inputting data to said computer through an Internet Web page.

18. The method of claim 8 including the steps of:
(a) providing radio frequency readers in a ball return passageway on billiard tables being used in a billiard tournament;
(b) embedding radio frequency identification tags associated with specific balls used on said table in said balls, said tags capable of being read by said reader when said balls passed through said ball passageway;
(c) transmitting data from said reader to said base computer regarding which balls pass through said ball passageway;
(d) using said data in said base computer to keep real time score of a game being played on said table; and
(e) displaying said score.
